(19) United States
(12) Patent Application Publication
(10) Pub. No.: US 2007/0075541 A1
(43) Pub. Date: Apr. 5, 2007

(54) Connection assembly for showerhead

(76) Inventor: James Wu, Taichung City (TW)

Correspondence Address: PRO-TECHTOR INTERNATIONAL SERVICES, 20775 NORADA CT., SARATOGA, CA, 95070, US

(21) Appl. No.: 11/243,339

(22) Filed: Oct. 3, 2005

(51) Int. Cl. F16L 27/00

(52) U.S. Cl. 285/272

(57) ABSTRACT

A connection assembly for showerheads includes a first part and a second part, wherein the first part includes a flange and a cylindrical portion which extends through the second part and a protrusion extends radially from the cylindrical portion and is rested on a distal end of the second part. The first part is connected with a hose and the second part is connected to showerhead. The second part is rotatably mounted to the first part between the protrusion and the flange. Therefore, the hose is not rotated with the rotation of the showerhead.

### FIELD OF THE INVENTION

The present invention relates to a connection assembly for showerheads and the showerheads can be rotated independently from the connection member while the hose is not twisted.

### BACKGROUND OF THE INVENTION

A conventional connection assembly for a showerhead 50 is shown in FIGS. 6 and 7, and generally includes a connection member 50 which includes a first threaded section 51 and a second threaded section 510, a flange is located between the first and second threaded sections 51, 510. The first threaded section 51 is threadedly connected to the showerhead 40 and the second threaded section 510 is connected to a hose which his not shown. It is noted that when using the showerhead 40, the hose is moved with the showerhead 40 and might be twisted. The twisted hose is easily damaged and when the user pulls the showerhead 40, leakage might happen at the joint area of the hose and the second threaded section 510.

The present invention intends to provide a connection assembly for showerheads and includes a first part for connecting a hose and a second part which is independently rotatably mounted to the first part. The second part is connected to the showerhead so that the hose is not rotated or twisted when operating the showerhead.

### SUMMARY OF THE INVENTION

The present invention relates to a connection assembly for showerheads and comprises a first part and a second part. The first part has a first flange extending radially therefrom and a cylindrical portion extends from a first side of the first flange and a first threaded section extends from a second side of the first flange. The first threaded section is connected to a hose. A protrusion extends radially from an outer periphery of the cylindrical portion. The second part has a second flange extending radially therefrom and the cylindrical portion of the first part extends axially through the second part and the protrusion is rested on a distal end of the second part. The second flange is rested on a top of the first flange. The second part has a second threaded section which is connected to a showerhead.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the showerhead with the connection assembly of the present invention;

FIG. 2 is an exploded view to show the showerhead and the connection assembly of the present invention;

FIG. 3 is an exploded view to show the connection assembly of the present invention;

FIG. 4 is a cross sectional view of the connection assembly of the present invention;

FIG. 5 is a cross sectional view to show that the showerhead is rotated independently from the hose;

FIG. 6 is a perspective view to show the showerhead with the conventional connection assembly, and

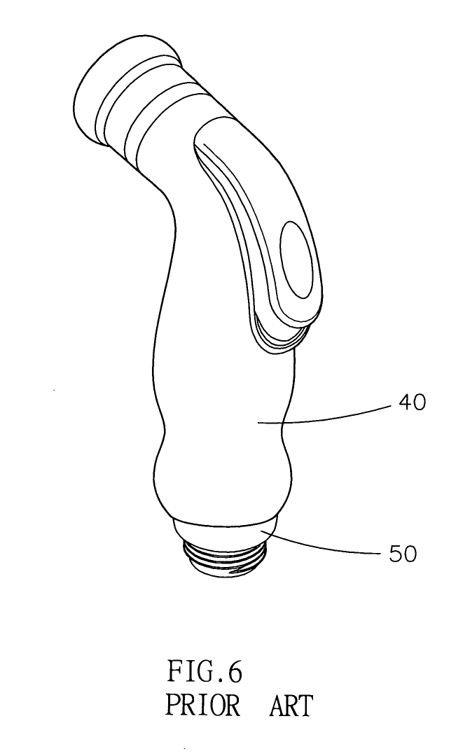

FIG. 7 is an exploded view to show the showerhead and the conventional connection assembly.

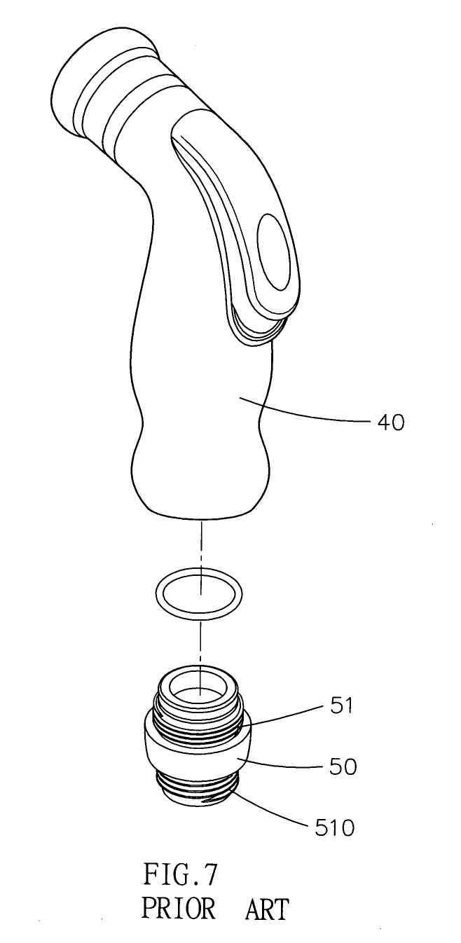

### DETAILED DESCRIPTION OF THE PREFERRED EMBODIMENT

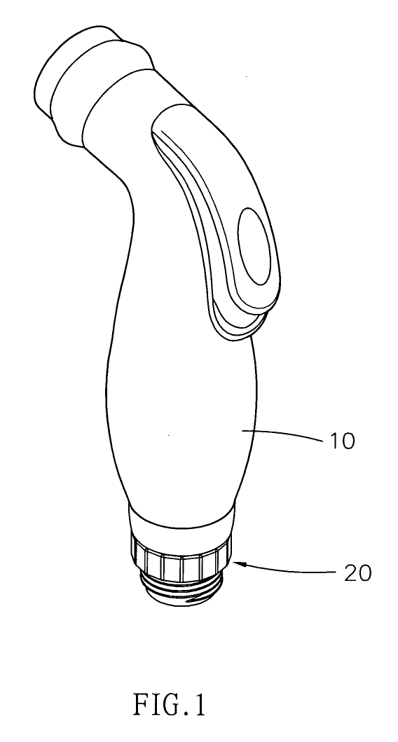

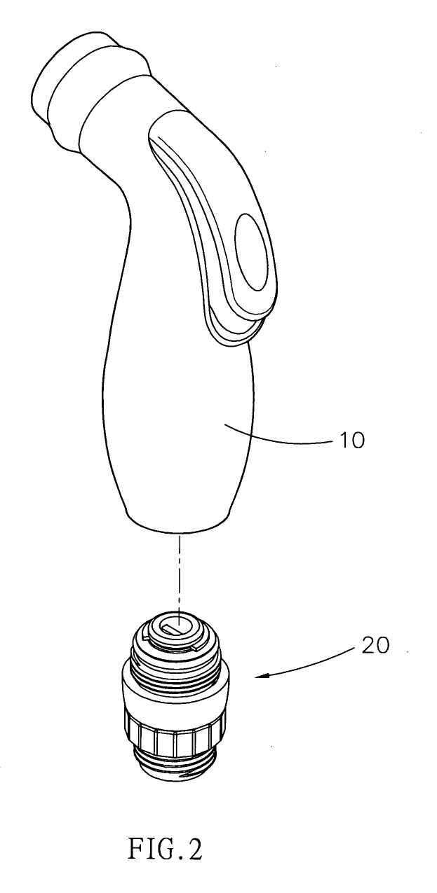

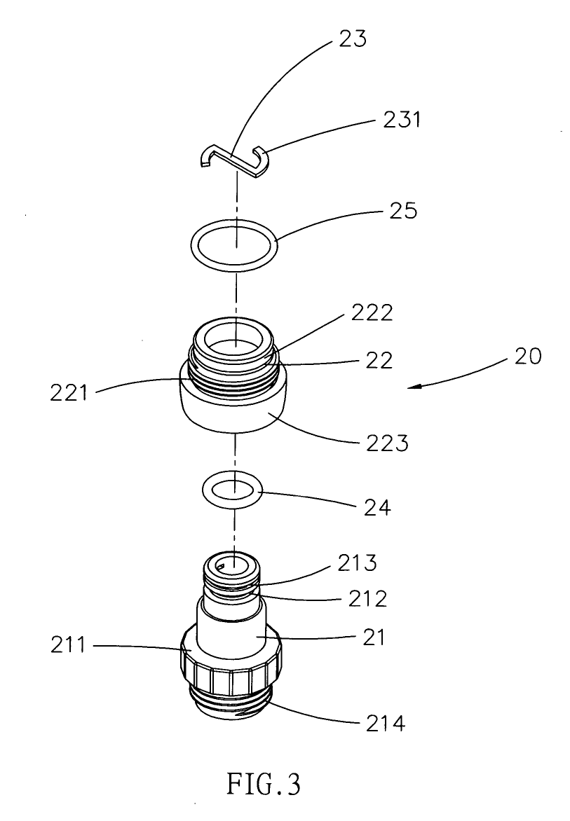

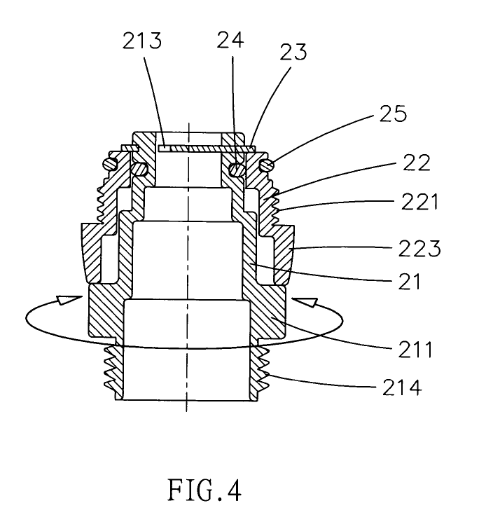

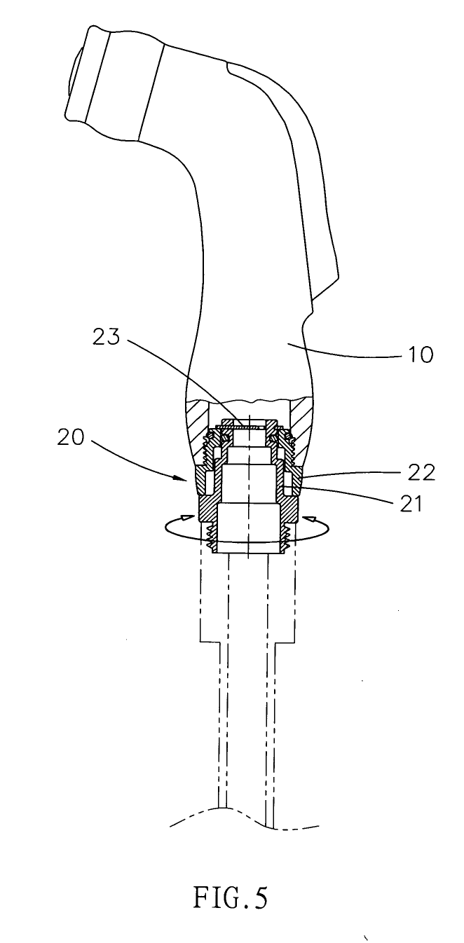

Referring to FIGS. 1 to 5, the connection assembly 20 for showerheads of the present invention comprises a first part 21 and a second part 22. The first part 21 has a first flange 211 extending radially therefrom and a cylindrical portion extends from a first side of the first flange 211 and a first threaded section 214 extends from a second side of the first flange 211. The first threaded section 214 is to be connected to a hose as shown in FIG. 5. The cylindrical portion includes a slot 213 defined radially through a wall thereof and a Z-shaped piece 23 extends through the slot 213. The two ends 231 of the piece 23 protrude radialy from an outer periphery of the cylindrical portion to form a protrusion. The two ends of the piece 23 are curve ends with flat top and bottom surfaces. The cylindrical portion includes a first groove 212 defined in the outer periphery thereof and a first seal 24 is engaged with the first groove 212.

The second part 22 has a second flange 223 extending radially therefrom and the cylindrical portion of the first part 21 extends axially through the second part 22. The protrusion is rested on a first end of the second part 22 and the second flange 223 is rested on a top of the first flange 223. In other words, the second part is rotatable relative to the first part 21. The second part 22 has a second threaded section 221 which is connected to a showerhead 10 or a nozzle. The second part 22 includes a second groove 222 defined in an outer periphery thereof and a second seal 25 is engaged with the second groove 222. The second groove 222 is located above the second threaded section 221.

The second part 22 is rotatably limited between the protrusion and the first flange 211 of the first part, the flat surface of the two curve ends 231 of the piece 23 allow the second part 22 is rotatable smoothly. Lubricant can also be applied to the first end of the second part 22 and the protrusion. When rotating the showerhead 10 relative to the hose, the hose is not rotated with the rotation of the showerhead 10 so that the hose is not twisted.

While we have shown and described the embodiment in accordance with the present invention, it should be clear to those skilled in the art that further embodiments may be made without departing from the scope of the present invention.

What is claimed is:

1. A connection assembly for showerheads, comprising:
a first part having a first flange extending radially therefrom and a cylindrical portion extending from a first side of the first flange and a first threaded section extending from a second side of the first flange, the first threaded section adapted to be connected to a hose, a protrusion extending radially from an outer periphery of the cylindrical portion, and
a second part having a second flange extending radially therefrom and the cylindrical portion of the first part extending axially through the second part and the protrusion rested on a first end of the second part, the second flange rested on a top of the first flange, the second part having a second threaded section which is adapted to be connected to a showerhead.

2. The assembly as claimed in claim 1, wherein the cylindrical portion includes a slot defined radially through a wall thereof and a piece extends through the slot, two ends of the piece protrude radialy from the outer periphery of the cylindrical portion to form the protrusion.

3. The assembly as claimed in claim 2, wherein the piece is a Z-shaped member and the two ends of the piece are curve ends with flat top and bottom surfaces.

4. The assembly as claimed in claim 1, wherein the cylindrical portion includes a first groove defined in the outer periphery thereof and a first seal is engaged with the first groove.

5. The assembly as claimed in claim 1, wherein the second part includes a second groove defined in an outer periphery thereof and a second seal is engaged with the second groove.

6. The assembly as claimed in claim 5, wherein the second groove is located above the second threaded section.
